(19) United States
(12) Patent Application Publication
(10) Pub. No.: US 2010/0204974 A1
(43) Pub. Date: Aug. 12, 2010

(54) Lidar-Assisted Stero Imager

(75) Inventors: Paul Israelsen, North Logan, UT (US); Robert T. Pack, Logan, UT (US)

Correspondence Address: UTAH STATE UNIVERSITY;Stoel Rives, 570 RESEARCH PARK WAY, SUITE 101, NORTH LOGAN, UT, 84341, US

(73) Assignee: Utah State University, North Logan, UT (US)

(21) Appl. No.: 12/368,057

(22) Filed: Feb. 9, 2009

(51) Int. Cl. G06G 7/62

(52) U.S. Cl. 703/17

(57) ABSTRACT

A lidar and one or more electro-optical (EO) imaging device may asynchronously acquire lidar shots and EO images. Navigation data comprising positioning, orientation, acceleration, and/or velocity information may be acquired as the lidar and EO data is captured. The lidar shots, EO images, and/or navigation data may be time stamped. The navigation and timing data may be used to associate a particular lidar shot and/or EO image with navigation data. The EO images may be captured at a higher capture rate and at a higher spatial resolution than the lidar shots. The navigation data may be used to cross correlate a lidar shot to a selected plurality of overlapping EO images. Ranging model information may be determined from EO image sequences using a stereo imaging technique. The stereo imaging technique may be seeded using the lidar shot data.

### TECHNICAL FIELD

The present invention relates to three-dimensional modeling. More specifically, the present invention relates to systems and methods for asynchronously acquiring correlatable lidar and electro-optical (EO) data.

### BRIEF DESCRIPTION OF THE DRAWINGS

Various embodiments of the invention are now described with reference to the figures, in which:

FIG. 1 is a block diagram of one embodiment of a lidar-assisted stereo imaging system;

FIG. 2A is a flow diagram of one embodiment of a method for asynchronously capturing correlatable lidar and EO imagery data to generate a model of a subject matter;

FIG. 2B is a flow diagram of another embodiment of a method for asynchronously capturing correlatable lidar and EO imagery data to generate a model of a subject matter;

FIG. 3 is a flow diagram of another embodiment of a method for asynchronously capturing correlatable lidar and EO imagery data;

FIG. 4A is an example of cross correlated lidar shots and EO images of a portion of a subject matter; and

FIG. 4B shows a lidar shot mapping to a selected plurality of EO images of a portion of a subject matter.

### DETAILED DESCRIPTION

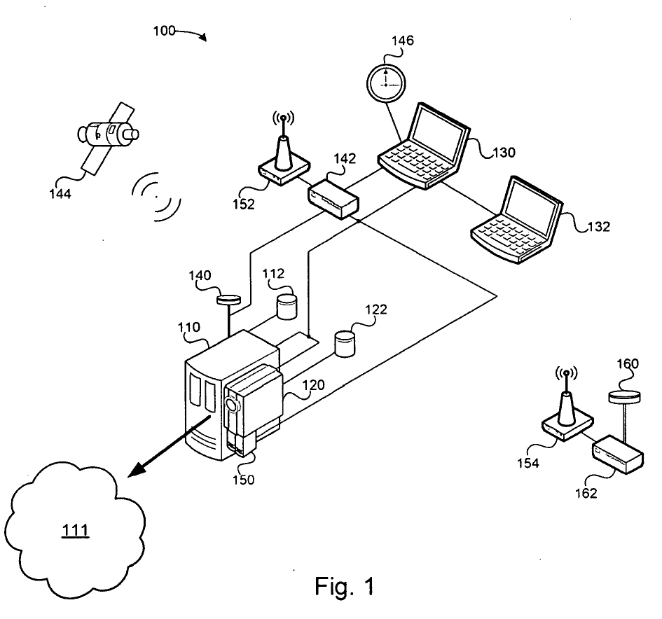

FIG. 1 depicts a block diagram of one embodiment of a lidar-assisted stereo imaging system 100. The system 100 may include a lidar 110 for scanning a subject matter 111 to thereby generate a plurality of lidar shots (e.g., distance measurements from the lidar 110 to the subject matter 111). The subject matter 111 may be any scannable structure including, but not limited to: an arbitrary object or structure, a landscape, a geographical area, a geographical feature, terrain, an extraterrestrial object, a coastline, ocean floor, or the like.

In some embodiments, the system 100 may be mobile. For instance, portions of the system 100 may be disposed in a vehicle (not shown). For example, the components 110, 112, 120, 122, 130, 132, 140, 142, 146, and 150 of the system 100 may be mounted within a car, aircraft, spacecraft, or the like. This may allow the system 100 to scan large geographical areas. Alternatively, or in addition, the lidar 110 and/or imaging device 120 may be mounted to a mounting device (not shown), such as a gimbal, a movable mount, a crane, or other device. The mounting device may be disposed in a vehicle, as discussed above. Alternatively, the location of the mounting device may be fixed and configured to move around the subject matter 111 to scan the subject matter 111 from various, different points-of-view, distances, angles, perspectives, and the like.

The lidar 110 may be any lidar device known in the art, such as a Riegl® airborne lidar, an LMS 291 lidar manufactured by SICK AG® of Waldkirch, Germany, or the like. The lidar 110 may be configured to obtain ranging information of the subject matter 111 (a plurality of lidar shots) by transmitting laser energy towards the subject matter 111 and detecting laser energy reflected and/or emitted therefrom. The resulting range points may be used by the system 100 in various ways. For example, the lidar shots may be used to generate a three-dimensional (3D) model (e.g., point cloud) of the subject matter 111. As will be discussed below, the model may be generated by a modeling module (depicted as a separate component, 132, in FIG. 1), which may be implemented as a component of the system controller 130 and/or as a separate computing device (as shown in FIG. 1). The lidar ranging data may be used to assist in the matching of portions of overlapping electro-optical (EO) imagery data (e.g., EO images), from which a highly accurate 3D model may be developed using, e.g., stereo imaging techniques. As used herein, a stereo imaging technique may refer to any modeling technique which constructs a 3D model of a subject matter based upon multiple EO images (e.g., on a sequence of multiple EO images). Examples of such techniques include stereo imaging, optical flow, match-moving, videogrammetry, photogrammetry, and the like.

The system 100 may further include an electro-optical (EO) imaging device 120 to capture electro-optical radiation reflected and/or emitted from the subject matter 111. The EO imaging device 120 may be an optical camera capable of detecting various forms of active and/or passive electro-optical radiation, including radiation in the visible wavelengths, infrared radiation, broad-spectrum radiation, X-ray radiation, or any other type of EO radiation. The EO imaging device 120 may be implemented as a video camera, such as a high-definition video camera, or other video camera type. In other embodiments, the EO imaging device 120 may include a still camera, a high-rate digital camera, computer vision camera, or the like.

The lidar 110 and EO imaging device 120 may be communicatively coupled to a system controller 130, which may be implemented as a computing device, which may include a processor (not shown). The processor may include a general purpose processor (e.g., a Core 2™ processor from Intel®, an Athlon™ processor from Advanced Micro Devices (AMD)®, or the like), a digital signal processor (DSP), a Field Programmable Gate Array (FPGA), an Application Specific Integrated Circuit (ASIC), a Programmable Logic Controller (PLC), or any other processing means known in the art. The system controller 130 may include a memory (not shown), which may include volatile and/or non-volatile memory storage. The memory may further include persistent data storage media, such as a fixed disc, optical storage media, and the like. The computer-readable storage media may include instructions to cause the system controller 130 to control the operation of the system 100. Various examples of methods and/or processes for operating the system 100 are discussed below. The system controller 130 may also include one or more input/output interfaces (not shown) to allow a user and/or other process to interact with the system controller 130 (e.g., view the status of the system 110, manage the programming system controller 130, and so on). The input/output devices may comprise a display, a keyboard, a pointing device, a mouse, one or more network interfaces, and the like.

The system controller 130 may include a communications interface (not shown). As depicted in FIG. 1, the communications interface may communicatively couple the system controller 130 to the lidar 110, the EO imaging device 120, and other components of the system 100 (e.g., the IMU 150, positioning system receiver 140, and so on, as discussed below). The communications interface may include a network interface, such as an Ethernet® interface, a wireless networking interface (e.g., IEEE 802.11a-n, Bluetooth®, cellular network, or the like), an RS232 interface, a public switched telephone network (PSTN) interface, a Universal Serial Bus (USB) interface, an IEEE 1394 interface (e.g., Firewire® interface), or the like.

The system controller 130 may control the operation of the various components of the system 100, including the lidar 110 and the EO imaging device 120. The system controller may configure the lidar 110 and the EO imaging device 120 to asynchronously capture correlatable data and to generate a 3D model of the subject matter 111 therefrom. The system controller 130 may cause the lidar 110 and EO imaging device 120 to capture data at different capture rates. In asynchronous operation, the lidar 110 may operate independently of the EO imaging device 120. This may allow the system 100 to incorporate commercial, off-the-shelf (COTS) components (a COTS lidar 110 and/or EO imaging device 120), which may reduce the cost of the system 100. Moreover, since the lidar 110 and the EO imaging device 120 operate independently, the system 100 may take full advantage of the capabilities of the lidar 110 and/or EO imaging device 120 (e.g., take advantage of a high capture rate of the EO imaging device 120 with respect to the lidar 110 or vice versa).

The lidar 110 and the EO imaging device 120 may be secured to respective mounts (not shown), such that lidar shots captured by the lidar 110 (e.g., a particular lidar shot) have a known or calculable relationship to a Field of View (FOV) captured by the EO imaging device 120. In some embodiments, the lidar 110 and the EO imaging device 120 may be co-mounted such that the orientation of the lidar 110 and the EO imaging device 120 are approximately the same and/or maintained at a known, fixed offset.

In some embodiments, the lidar 110 and the EO imaging device 120 may be co-boresighted, such that the lidar 110 is configured to capture the same specific solid angle within the FOV of the EO imaging device 120. In this embodiment, laser energy reflected and/or emitted from the subject matter 111 may be returned to the lidar 110 at the same solid angle within the FOV as the EO imaging device 120.

Due to the movement and asynchronous operation of the lidar 110 and the EO imaging device 120 relative to subject matter 111, accurate instantaneous correlation between lidar shots and EO imagery may be difficult or impossible. As discussed above, the lidar 110 and the EO imaging device 120 may be mounted on a mobile platform (e.g., in an aircraft, crane, or other vehicle). As such, a lidar shot captured at a first time t₁ may not be correlatable to an EO image captured at a different time t₂, due to inter alia, effects of parallax, movement of subject matter 111 within the FOV, movement of the system 100, and/or forces acting of the system 100 (e.g., perturbations, acceleration, etc.). This may be the case even if the FOV of the lidar 110 and the EO imaging device 120 correspond to one another and/or are fixed at a known offset within the system 100.

In order to asynchronously capture correlatable data, the system 100 may be configured to capture navigation, orientation (pose), and/or timing information as lidar shot and EO imagery data are acquired by the lidar 110 and/or EO imaging device 120. As will be discussed below, the navigation information may comprise a position of the system 100, including a position of the lidar 110 and/or EO imaging device 120. The navigation information may also include an individual orientation (pose) of the lidar 110 and/or EO imaging device 120. The orientation information may include a vector representation of a direction the lidar 110 and/or EO imaging device 120 is pointed, forces acting on the lidar 110 and/or EO imaging device 120, and the like. The navigation information may further comprise acceleration and/or velocity information indicating an acceleration and/or velocity of the lidar 110 and/or EO imaging device 120. The timing information may indicate a precise time particular lidar shots and/or EO images are obtained. In some embodiments, the navigation data may be time stamped to allow lidar and/or EO imagery data to be correlated thereto.

The system 100 may capture navigation and/or timing information concurrently with the capture of each lidar shot and/or EO image. Alternatively, or in addition, the navigation and/or timing information may be continuously recorded, and lidar shots and/or EO images may be correlated thereto using respective time stamps. The navigation and/or timing information associated with each of the respective lidar shots and/or EO images may be stored in a respective data storage media 112 or 122. As will be discussed in additional detail below, the navigation and/or timing information associated with the lidar shots and/or EO images may allow the lidar shots and/or EO images to be spatially correlated to one another (e.g., may allow the position of one or more lidar shots to be mapped onto one or more EO images and vice versa). As such, a lidar shot may be mapped to and positioned within a particular set of pixels (image patch) within one or more EO images. As will be discussed below, this lidar shot-to-EO image mapping may be used to seed an image matching process of a stereo imaging technique (e.g., to match image patches of overlapping EO images).

As discussed above, the lidar 110 and the EO imaging device 120 may be mounted at fixed positions relative to one another. The lidar 110 and the imaging device 120 may be mounted using any mounting technique and/or mounting means known in the art including, but not limited to: a fixed mount, a gimbal mount, a mobile mounting device (e.g., a crane or the like), or a similar device. In some embodiments, the lidar 110 and EO imaging device 120 may be co-boresighted (e.g., share the same optical axis and position) using a cold mirror or the like. In other embodiments, the lidar 110 and the EO imaging device may be mounted on an optical bench (not shown), such that the FOV captured by the lidar 110 corresponds to the FOV captured by the EO imaging device 120. In other embodiments, the lidar 110 and the EO imaging device 120 may be mounted within the system 100, such that there is a known, fixed mapping between the FOV captured by the lidar 110 and the FOV captured by the imaging device 120. Accordingly, given navigation and/or timing information of a lidar shot obtained by the lidar 110 and a EO image obtained by the EO imaging device 120, a relationship between the FOV captured by the EO imaging device and the area captured by a particular lidar shot may be determined, allowing asynchronously obtained lidar and EO imagery data to be cross correlated.

In asynchronous operation, the lidar 110 may capture data (lidar shots) at a different capture rate and/or at different times than the EO imaging device 120. For example, the EO imaging device 120 may be capable of capturing EO imagery data at an EO image capture rate of 30 frames per second. The EO capture rate may be dependent upon the type of EO imaging device 120 used in the system 100. The lidar 110 may be capable of capturing lidar shots at a lidar shot capture rate and according to a particular lidar scan pattern (e.g., in a linear scan, in a scan array, and so on). The data captured by the lidar 110 and EO imaging device 120 may be stored in respective storage media 112 and 122. In other embodiments, the lidar 110 and the EO imaging device 120 may share a common data storage media (not shown). The data storage media 112 and 122 may comprise any data storage media known in the art including, but not limited to: a memory (volatile or non-volatile), a fixed disc, a removable disc, magnetic data storage media, optical data storage media, distributed data storage media, a database (e.g., a Structured Query Language (SQL) database or the like), a directory (e.g., an X.509 director, a Lightweight Directory Access Protocol (LDAP) directory, or the like), a file system, or the like.

The system 100 may further include a positioning system antenna 140, which may be configured to receive positioning data from a positioning system transmitter 144, such as one or more global positioning system (GPS) satellites, a wireless networking positioning system (not shown), one or more satellites of the Galileo positioning system proposed by the European Union, one or more satellites of the GLONASS positioning system, or the like.

The positioning system antenna 140 may be communicatively coupled to a positioning system receiver 142, which may be configured to determine a position of the lidar 110 and/or the EO imaging device 120 using the positioning information received via the positioning system antenna 140.

In some embodiments, the accuracy of the positioning information may be augmented by a secondary positioning system receiver 162 (and secondary antenna 160). The secondary positioning system receiver 162 and antenna 160 may be disposed at a known location relative to the rest of the system 100, and may be used to detect and compensate for errors in the positioning information received via the antenna 140. For instance, some satellite-based positioning systems (e.g., GPS) may be subject to error caused by variable transmission delays between the transmitter 144 and the antenna 140 and 160, these delays may be induced by shifts in the Earth's ionosphere or other conditions.

The secondary positioning system receiver 162 may be positioned at a known location. In some embodiments, the secondary positioning system receiver 162 may be at a fixed location in the general proximity (e.g., within a few miles) of the system 100. Since the position of the secondary positioning system receiver 162 and/or antenna 160 is known, any changes in the position observed at the secondary receiver 162 may represent an error. The positioning error information received at the secondary receiver 162 may be transmitted to the positioning system receiver 142 and/or the computing device 150 via a communications interface, such as a radio modem 154. The positioning system receiver 142 and/or system controller 130 may refine the positioning information received from the positioning system transmitter 144 using the position error values provided by the secondary positioning system receiver 162.

Alternatively, or in addition, the secondary positioning system receiver 162 may be communicatively coupled to a data storage media (not shown) and/or to secondary positioning system timing means (not shown). The secondary positioning system receiver 162 may be configured to store time-stamped positioning information in the storage media. The data stored by the second positioning system 162 may be accessed later to refine the positioning data received by the positioning system receiver 142.

The system 100 may further include one or more inertial measurement units (IMU) 150, which may be configured to sense and/or measure the motion characteristics of the lidar 110 and EO imaging device 120 using one or more accelerometers (not shown), gyroscopes (not shown), or the like. The IMU 150 may detect the orientation, acceleration, velocity, rotation rate, and/or movement of the lidar 110 and/or EO imaging device 120 (e.g., including the rotation and/or orientation). The IMU 150 may be configured to measure different types of movement and/or acceleration forces acting on the lidar 110 and/or EO imaging device 120 (e.g., if the lidar 110 and EO imaging device 120 are disposed within an aircraft, the IMU 150 may be configured to measure roll, pitch, yaw, and the like).

The data captured by the IMU 150 may make up part of the navigation data and may be stored in a computer-readable storage medium, such as the storage media 112 and/or 122. The movement and/or orientation data recorded by the IMU 150 may be used with or without the aid of the positioning system comprising elements 140, 142, and 144 (e.g., a satellite based system) to estimate the orientation (pose) of the lidar 110 and/or EO imaging device 120. If the lidar 110 and/or EO imaging device 120 are mounted using a movable mount (gimbal mount or the like) not directly attached to the IMU 150, the IMU 150 information may be combined with the mount position information to determine the orientation of the devices 110 and/or 120.

The IMU 150 data may also be used to refine the position of the lidar 110 and/or EO imaging device 120. The positioning system may be configured to update the position of the system 100 at a particular interval (e.g., at a particular update frequency). The update frequency may be fixed by the positioning system (e.g., the positioning system components, such as the transmitter 144, may be configured to transmit position information at a pre-determined interval or frequency). However, if the lidar 110 and/or EO imaging device 120 are moving (e.g., are housed within a vehicle, such as an aircraft), the position of the lidar 110 and/or EO imaging device 120 may change between positioning system updates. In this case, the movement and orientation data obtained by the IMU 150 may be used to calculate a more precise position of the system 100 using, for example, a technique, such as dead reckoning or the like.

The system controller 130 may be coupled to a time source 146, which may provide a reference time signal to the system controller 130. The time source 146 may be provided by the positioning system transmitter 144. The positioning system transmitter (e.g., a GPS positioning system transmitter) may include a time reference signal along with positioning information. As such, the positioning system antenna 140 and/or positioning system receiver 142 may be configured to obtain a time reference signal from the positioning system transmitter 144. This signal may be used as the time source 146.

In other embodiments, the time source 146 may be a high-precision timing device, such as a clock. The time source 146 (clock) may be synchronized to an external time reference, which may be provided by the positioning system transmitter 144 or another source, such as a radio transmitter. For example, the time source 146 may be synchronized to a time reference signal transmitted by a long wave transmitter on WWVB by the National Institute of Standards and Technology (NIST) or the like. The time source 146 clock may comprise a high-precision timing device, such as an atomic clock, selenium clock, or the like. In some embodiments, the timing information provided by the time source 146 may be maintained independently of a reference time signal (e.g., may be independent of the time reference embedded in positioning information transmitted by the positioning system 144).

The time source 146 may provide precise timing information to the system controller 130, which may time stamp lidar shots obtained by the lidar 110 and/or EO images obtained by the EO imaging device 120. The navigation and/or orientation data may be similarly time stamped. As such, the navigation and/or orientation data of any lidar shot and/or EO image may be determined using the time stamp associated therewith.

The lidar 110 may be configured to store lidar shot information in the lidar data storage media 112. The navigation and/or timing information obtained concurrently with the lidar shot may also be stored in the lidar data storage media 112. The navigation and/or orientation data may be associated (e.g., linked to) a respective lidar shot in the lidar data storage media 112. The association may be implemented in a number of different ways including, but not limited to: associating the lidar shot and navigation data using a time tag; storing the navigation and/or timing information as a part of the lidar shot data (e.g., as a header, footer, or other appendage to the lidar shot data); linking a separate data file and/or record comprising the navigation and/or timing information to a data file and/or record comprising the lidar shot (e.g., via file naming, file system directory structure, or the like); including a reference to the navigation and/or timing data in the lidar shot (e.g., embedding a link to the navigation and/or timing data in the lidar data); associating the navigation and/or timing information with the lidar shot data in a database (e.g., within a table of relational database, such as an SQL database, or the like); associating the navigation and/or timing information with the lidar shot data in a structured data format, such as an eXtensible Markup Language (XML) data format; or the like.

In other embodiments, the system controller 130 may be configured to store lidar shot data and timing information separately from the navigation and orientation information. In this embodiment, the system controller 130 may store time-stamped navigation and orientation data in a data store (e.g., the storage media 112 and/or 122 or another storage location (not shown)). The lidar data may be time stamped and stored in the storage media 112. Individual lidar shots may be correlated to a navigation and/or orientation data using respective time stamps. EO imagery data acquired by the EO imaging device 120 may be stored and/or correlated to navigation and/or timing data as described above.

The system controller 130 may be configured to control the position and/or orientation of the lidar 110 and/or the EO imaging device 120. For example, the lidar 110 and/or the EO imaging device 120 may be mounted on a gimbal mount (not shown) or other adjustable mounting means, which may be coupled to one or more articulation means (e.g., motors or the like). The system controller 130 may be configured to orient the lidar 110 and/or EO imaging device 120 to capture various portions of the subject matter 111 (e.g., from different angles, points of view, and the like). The system controller 130 may be configured to directly track the orientation of the lidar 110 and/or the EO imaging device 120 via encoders on the gimbal mount and to include the orientation information with the navigation information discussed above. Alternatively, or in addition, the system controller 130 may track changes in orientation of the lidar 110 and/or EO imaging device 120 using the IMU 150. The changes in orientation detected by the IMU 150 may be received by the system controller 130, which may track the orientation of the lidar 110 and/or EO imaging device 120 and/or include the orientation information with the navigation information, as discussed above.

As discussed above, the system controller 130 may cause the lidar 110 and EO imaging device 120 to asynchronously capture lidar and EO imagery data at respective capture rates. The EO imaging device 120 may be capable of capturing EO images at a relatively high rate as compared to the lidar 110. As such, the EO imaging device 120 may capture many overlapping EO images of the subject matter 111. For example, the EO imaging device 120 may be an HD video camera capable of capturing 30 or 60 frames of EO image data per second. As such, the EO imaging device 120 may capture a large amount of overlapping data from image to image, causing an object in the FOV of the EO imaging device 120 may be captured in many different EO images (e.g., frames), and hence from many different viewpoints.

The overlapping EO imagery data may be used to model the subject matter 111 using a stereo imaging technique. For instance, the various points of view captured by the EO imaging device 120 may be used in a stereo imaging and/or videogrammetry-based technique to construct a 3D model of the subject matter. The lidar shot data captured by the lidar 110 may be used to assist (e.g., seed) the stereo matching technique to increase the accuracy and/or decrease the computation time of the 3D model processing and/or to refine the navigation and/or pose measurements obtained by the system 100. In addition, optical flow techniques may be applied to the overlapping EO imagery data to further refine the 3D models.

A modeler 132 may be configured to generate a 3D model of the subject matter 111 using a stereo imaging technique. The modeler 132 may be implemented as part of the system controller 130 (e.g., as a software module, co-processor, etc. on the system controller 130) and/or may be implemented on a separate computing device. In the FIG. 1 embodiment, the modeler 132 is shown as a separate computing device, which may comprise processing means (e.g., a general and/or special purpose processor), memory, data storage media, a human-machine-interface (HMI), and the like. The modeler 132 may be communicatively coupled to the system controller 130 and/or data storage media 112 and 122 to access the lidar shots, EO images, navigation, and timing data stored thereon. The modeler 132 may be continuously coupled to the system controller 130 and/or may be selectively coupled to the system controller 130.

In some embodiments, the modeler 132 may be configured to model the subject matter 111 in real-time (e.g., as the system 100 scans the subject matter 111). In this case, the modeler 132 may be configured to provide real-time feedback to the positioning system receiver 140 and/or IMU 150 to increase the accuracy of their measurements. Alternatively, the data captured by the system 100 may be transferred to the modeler 132, which may generate the model of the subject matter after the data has been captured (e.g., “off-line”).

As discussed above, the modeler 132 may be configured to model the subject matter using an EO image-based modeling technique, such as a stereo imaging technique, videogrammetry, photogrammetry, or the like. The modeler 132 may be configured to seed the modeling technique using the lidar shots. This may be done by mapping one or more of the plurality of lidar shots into a selected plurality of overlapping EO images. These mappings may be calculated using the navigation, orientation, and/or timing data associated with the lidar shots and EO images. Seeding the EO imaging-based modeling technique in this manner may increase the accuracy of the EO image-based modeling technique and/or may decrease the compute time required to generate the model.

As discussed above, the modeler 132 may include a HMI interface, which may allow a human user (or other process) to interact with the model of the subject matter 111. For example, the HMI include a display device (e.g., a monitor, a printer, or the like), which may be used to display the model of the subject matter 111 to the human user. The HMI may further include input/output devices, which may allow the user (or another process) to control how model is generated (e.g., control various modeling parameters used by the modeler 132), provide various visualizations and/or perspective views of the model (e.g., wireframe, textured, etc.), and the like.

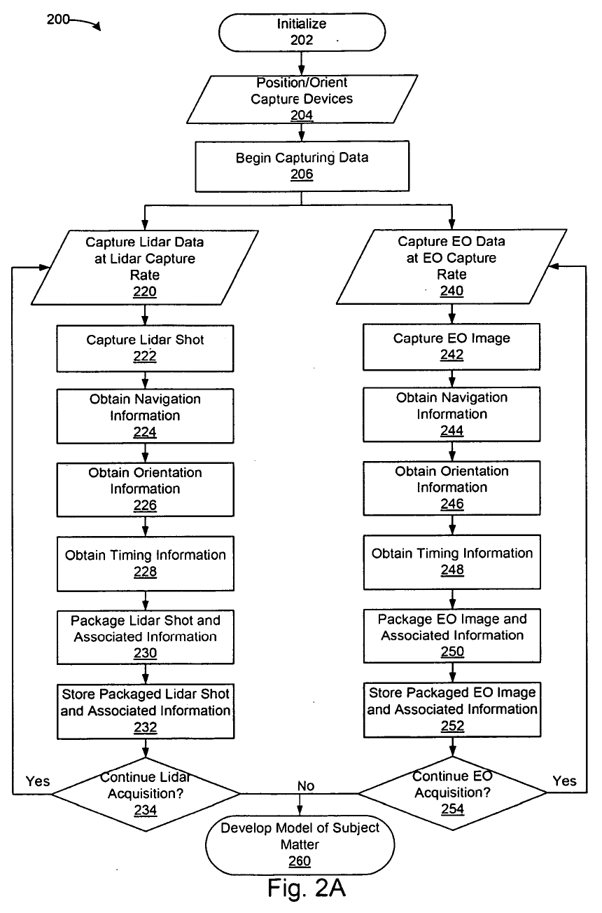

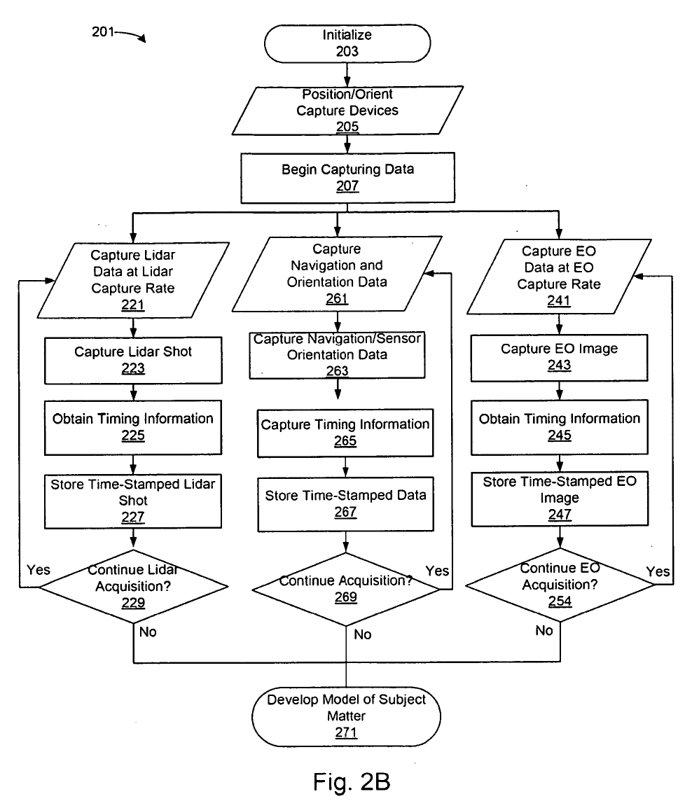

FIG. 2A is a flow diagram of one embodiment of a method 200 for asynchronously capturing correlatable lidar and EO data to generate a model of a subject matter. The method 200 may be performed by a computing device, such as the system controller 130 and/or modeler 132 of FIG. 1. Accordingly, the method 200 may be implemented as one or more computer-readable instructions stored on a computer-readable storage medium.

At step 202, the method 200 may be initialized, which may comprise loading executable program code from a computer-readable data storage media, allocating resources for the method 200 (e.g., allocating memory, data storage media, accessing communication interfaces, and the like), and/or initializing resources for the method 200 (e.g., initializing memory, data storage media, communications interfaces, and the like).

At step 204, a lidar and/or EO imaging device may be positioned and/or oriented to capture lidar ranging data and/or EO images of a particular subject matter. The positioning and/or orienting of step 202 may comprise moving the lidar and/or EO imaging device to capture subject matter spanning a large area (e.g., a coastline, large geological feature, or the like). Accordingly, the positioning and/or orienting of the lidar and/or EO imaging device described in step 204 may occur continuously during the method 200 (e.g., the lidar and/or EO imaging device may be disposed within a moving vehicle, such as a car, crane, aircraft, spacecraft, satellite, or the like).

At step 206, the lidar and/or EO imaging device may begin capturing data. The lidar and EO imaging device may capture data asynchronously. During asynchronous operation, the lidar may be configured to obtain a lidar shot at a first time t₁ and/or at a particular lidar shot frequency f₁ (e.g., 100,000 shots per second), and the EO imaging device may be configured to obtain an EO image at a second, different time t₂ and/or at a different EO image capture frequency f₂ (e.g., at 30 frames per second). As discussed above, in some embodiments, the EO imaging device may be capable of acquiring EO images at a higher rate than the lidar is capable of acquiring lidar shots (e.g., the capture frequency f₂ of the EO imaging device 120 may be greater than the capture frequency f₁ of the lidar 110). This may result in the method 200 capturing more EO imagery data than lidar data. In addition, the EO imagery data may capture overlapping images of the same portion of the subject matter. As discussed above, the overlapping EO imagery data may be used to develop a 3D model of the subject matter using, inter alia, stereo imaging techniques.

The operation of the lidar and the EO imaging device in method 200 may be performed within two (2) independent processes. In FIG. 2A, the steps 220-232 may represent the asynchronous operation of the lidar, and the steps 240-252 may represent the asynchronous operation of the EO imaging device. Although the operation of the lidar and the EO imaging device are described sequentially, one skilled in the art would recognize that the method 200 could be implemented to allow for concurrent, asynchronous execution of the steps 220-232 and 240-252. For example, the steps 220-232 and/or 240-252 may be implemented as separate processes and/or threads on a processor (e.g., on the system controller 130 of FIG. 1), may be implemented on separate processors and/or on separate processor cores, may be implemented on separate computing devices (e.g., in a distributed computing environment), or the like.

At step 220, a lidar may be configured to begin capturing lidar data at a particular capture rate and according to a particular lidar scan pattern. The capture rate and/or scan pattern may be determined by the capabilities of the particular lidar (e.g., a maximum capture rate of the lidar), the requirements of the method 200, and/or the requirements of a particular application (e.g., the desired resolution, positioning speed, or the like). As discussed above, the steps 220-232 may be repeated according to the lidar shot capture frequency.

At step 222, the lidar may capture a lidar shot. The lidar shot of step 222 may be obtained by a lidar, such as the lidar 110 of FIG. 1.

Concurrently with step 222, at step 224, navigation information may be obtained. The navigation information may indicate a position of the lidar at the time the lidar shot of step 222 was captured. As discussed above, obtaining navigation information may comprise accessing positioning information from a positioning system, such as a GPS system or the like. The positioning information may be refined using positioning information received at a second positioning system located at a known position as described above (e.g., variations from the known position of the second positioning system receiver may be used to refine the positioning information received at step 224).

Obtaining navigation information may further comprise accessing an IMU or other device to extrapolate a current position of the lidar based on a heading, velocity, and/or acceleration of the lidar (e.g., using dead reckoning or another technique).

In some embodiments, at step 226, and concurrently with step 222, a precise orientation (pose) of the lidar may be determined. The orientation of the lidar may be derived from an orientation of a mounting device of the lidar (e.g., a gimbal or other mounting device) and/or may be based on data received from an IMU coupled to the lidar. At step 226, the position of the lidar (obtained at step 224), the position of the lidar mount, and/or IMU data may be combined to determine an actual orientation of the lidar.

Concurrently with step 222, at step 228, timing information may be obtained. The timing information may indicate a precise time the lidar shot was captured. In some embodiments, the timing information may indicate a time the lidar capture began and a time the lidar capture was completed (e.g., the timing information may include a time window during which the lidar shot was captured).

At step 230, the lidar shot, the navigation information, the orientation information, and/or the timing information may be packaged for storage in a computer-readable storage media. In some embodiments, the packaging of step 230 may comprise appending the navigation, orientation, and/or timing information (e.g., comprising a position, movement, orientation, and/or lidar shot timing) to the lidar shot data as a header, trailer, or other appendage. Alternatively, or in addition, the packaging of step 230 may comprise establishing a link between the lidar shot data and the positioning, orientation, and/or timing data. The link may comprise a file naming convention, a common time stamp or other identifier, a location in a file system, an association in a data storage system (e.g., a database key or the like), an association in a data structure (e.g., a structural and/or referential relationship in XML or other structured data format, or the like), or any other data association means known in the art.

At step 232, the packaged lidar shot and associated data may be stored in a data storage media. The data storage media of step 232 may comprise any data storage media known in the art and may include local and/or remote data storage means (e.g., may comprise a local memory, disc, or the like; and/or one or more distributed and/or network accessible data storage locations).

At step 234, the method 200 may determine whether lidar data acquisition should continue. If so, the flow may return to step 220 where a next lidar shot may be acquired; otherwise, the flow may continue at step 260.

Concurrently with the lidar capture steps of 220-232, the method 200 may asynchronously capture EO data at step 240-252. As such, the method 200 may concurrently perform steps 220-232 and step 240-252. As would be appreciated by one skilled in the art, the steps 220-232 and steps 240-252 may be performed at different capture frequencies and/or capture intervals. For example, the lidar of method 200 may be configured and/or capable of obtaining a lidar shot in a first time period t₁ and/or at a particular capture frequency f₁, and the EO imaging device of the method 200 may be configured and/or capable of obtaining an EO image in a second, different time period t₂ and/or at a different EO image capture frequency f₂. Accordingly, the time required by the method 200 to perform steps 220-232 may be defined by inter alia the lidar shot time t₁ and/or lidar shot frequency f₁, and the time required by the method 200 to perform steps 240-252 may be defined by inter alia the EO image capture time period t₂ and/or EO image capture frequency f₂. Moreover, a particular application may call for the use of a higher ratio of EO imagery to lidar shot data or vice versa. In such embodiments, the method 200 may be configured to capture lidar data at steps 220-232 and/or EO imagery data at steps 240-252 at different capture rates that are independent of the lidar shot capture time and/or EO image capture time.

At step 240, an EO imaging device (such as the EO imaging device 120 of FIG. 1) may be configured to begin capturing EO imagery data at a particular capture rate. The capture rate of the EO imaging device may be determined by the capabilities of the particular EO imaging device (e.g., a maximum capture rate of the EO imaging device), the requirements of the method 200, and/or the requirements of a particular application (e.g., based on a desired resolution, positioning speed, or the like). As discussed above, the steps 240-252 may be repeated according to the EO image capture frequency.

Concurrently with step 242, at step 244, navigation information may be obtained. As discussed above, the navigation information may indicate a precise position of the EO imaging device at the time the EO image of step 242 was captured. The positioning information may be obtained as discussed above, and may comprise accessing a position from a positioning system, accessing information from a secondary positioning system, and/or refining the positioning information using data from an IMU or similar device.

In some embodiments, at step 246 (which may be performed concurrently with step 242), a precise orientation of the EO imaging device may be determined as discussed above.

Concurrently with step 242, at step 248, timing information may be obtained. The timing information may indicate a precise time the EO image was obtained. The timing information of step 248 may be obtained as described above. In some embodiments, the timing information may indicate a time the EO image capture began and a time the EO image capture was completed (e.g., may include the time required to capture the EO image).

At step 250, the EO image data, the navigation information, the orientation information, and/or the timing information may be packaged for storage in a computer-readable storage media. In some embodiments, the packaging of step 250 may comprise appending the navigation, orientation, and/or timing information (e.g., comprising a position, movement, orientation, and/or EO image timing) to the EO imagery data as a header, trailer, or other appendage to the data. Alternatively, or in addition, the packaging of step 250 may comprise establishing a link between the EO imagery data and the positioning, orientation, and/or timing data as described above.

At step 252, the packaged EO imagery data and associated data (e.g., navigation, orientation, and/or timing) may be stored in a computer-readable storage media. The storage media of step 252 may comprise any data storage media known in the art and may comprise local and/or remote data storage means (e.g., may comprise a local memory, disc, or the like, and/or one or more distributed and/or network accessible data storage locations).

At step 254, the method 200 may determine whether EO data acquisition should continue. If so, the flow may continue at step 240 wherein a next EO image may be captured; otherwise, the flow may continue at step 260.

At step 260, the method 200 may develop a 3D model of the subject matter captured in steps 220-232 and 240-253. The model may be generated using the overlapping EO imagery data captured at step 240-252 using, inter alia, stereo imaging techniques. In some embodiments, the stereo imaging technique may be seeded using the lidar data. For example, a particular lidar shot may be mapped to a selected plurality of EO images using the ranging information in the lidar shot and the navigation and/or timing data of the lidar shot and EO images. The location of the lidar shot within the selected plurality of EO images may be used as a seed to match image patches (groups of pixels) within the overlapping EO images as part of a stereo imaging modeling technique. For example, the location of the lidar shot within the selected plurality of images may be used as a seed point for an image matching operation between the selected plurality of images (since the image patch to which the lidar point maps in each of the EO images should represent the same portion of subject matter across all of the EO images).

FIG. 2B is a flow diagram of another embodiment of a method 201 for asynchronously capturing correlatable lidar and EO imagery data to model a subject matter. At steps 203 and 205, the method 201 may be initialized and the lidar and EO imaging device may be positioned as described above. At step 207, the method 201 may cause the lidar and EO imaging device to begin capturing data on the subject matter.

As discussed above, the lidar and EO imaging device may capture data asynchronously. As such, the process for capturing lidar data (steps 221-229) may be independent of the process for capturing EO imagery data (steps 241-249). As described above, these steps may be implemented as independent processes or threads on a single processor and/or may be implemented on different processor cores, processing devices, or the like. In addition, as will be discussed below, the steps 261-269 for acquiring navigation data may be performed independently of the lidar steps 221-229 and EO imaging steps 241-249.

At step 221, the lidar may capture lidar shot data according to a particular lidar capture rate and accordingly to a particular lidar scan pattern as described above. At step 223, a lidar shot may be captured. At step 225, timing information indicating the time the lidar shot was captured may be acquired from a time source (e.g., clock). At step 227, the time-stamped lidar shot may be stored in a data storage medium. At step 229, the method 201 may determine whether lidar capture should continue. If so, the flow may continue at step 221; otherwise, the flow may continue at step 271.

At step 241, the EO imaging device may capture EO images according to a particular EO image capture rate. At step 243, an EO image may be captured. At step 245, timing information indicating the time the EO image was captured may be obtained from a time source (e.g., clock). At step 247, the time-stamped EO image may be stored in a data storage medium. At step 249, the method 201 may determine whether EO image capture should continue. If so, the flow may continue at step 241; otherwise, the flow may continue at step 271.

At step 261, navigation and sensor orientation data may be acquired at a particular acquisition rate. The acquisition rate of may be dependent upon the instruments used to capture the data and/or the needs of the method 201 (e.g., precision requirements or the like). For example, a positioning system transmitter (e.g., GPS satellite) may broadcast updates at a particular interval. Alternatively, or in addition, the method 201 may acquire navigation and/or sensor orientation data at another update frequency tailored to the requirements of the method 201. The update frequency of the navigation and orientation data may be independent of the capture rate of the lidar and/or EO imaging device.

At step 263, navigation and sensor orientation (pose) information may be captured. As discussed above, the navigation information may indicate a position of the lidar and the EO imaging device. The orientation information may indicate an orientation (pose) of the lidar and the EO imaging device (e.g., the direction in which the lidar and/or EO imaging device are pointed). The orientation information may further indicate a velocity of the lidar and/or EO imaging device, and may include measurements of other forces acting on the devices (e.g., using an inertial measurement unit or the like).

Concurrently with step 263, at step 265, a time reference indicating the time the navigation and orientation data were obtained may be acquired. In some embodiments, the timing data may be stored as discrete time values. In other embodiments, the timing information may be recorded as a separate data stream to which the navigation and orientation data are correlated.

At step 267, the time-stamped navigation and orientation data may be stored in a data storage medium. Alternatively, the navigation and orientation data streams may be stored independently of the timing data stream.

At step 269, the method 201 may determine whether data acquisition should continue. If so, the flow may continue at step 261; otherwise, the flow may continue at step 271.

At step 271, a 3D model of the subject matter may be developed using the overlapping EO images in a stereo imaging technique. Since the EO imagery data may be captured at a higher capture rate and/or at a higher spatial resolution than the lidar shot data, the resulting 3D model of the subject matter may provide higher accuracy and detail (resolution) than a model based on the lidar data. The stereo imaging technique may be seeded using the lidar shot data. Lidar shots may be used to seed the EO image matching required for stereo imaging by mapping one or more lidar shots into one or more selected sets of EO images. The mapping may be made using the ranging data in the lidar shots and navigation and orientation data recorded at steps 261-269. The navigation and orientation data of a particular lidar shot may be obtained by accessing navigation data having the same time stamp as the lidar shot. If the time stamp of the lidar shot falls “in between” navigation data samples, the navigation and orientation data may be interpolated from surrounding navigation and/or orientation data samples (e.g., using dead reckoning techniques in conjunction with velocity and other data acquired by an IMU).

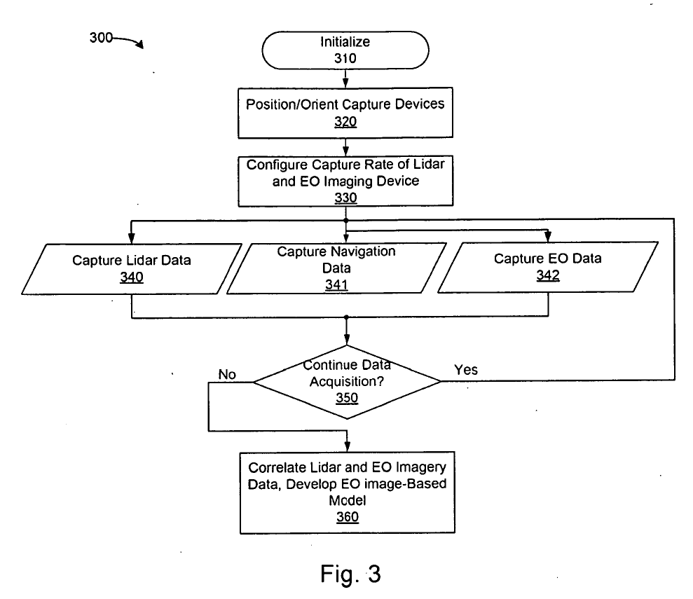

FIG. 3 is a flow diagram of one embodiment of a method 300 for capturing correlatable lidar and EO imagery data to generate a 3D model of a subject matter, wherein the EO imagery data has a many-to-one ratio with respect to the lidar data.

As discussed above, in some embodiments of the lidar and EO image capture systems and methods disclosed herein, the EO imaging device may be configured to capture EO imagery at a higher capture rate than the lidar (e.g., the EO imaging device may capture a plurality of EO images for every one lidar shot captured by the lidar). The increased amount of EO imagery data relative to the lidar data may allow EO image processing techniques to be leveraged to develop a 3D model of the subject matter scanned by the EO imaging device and lidar (e.g., using stereo imaging techniques, videogrammetry techniques or the like). The EO imagery-based modeling techniques may be seeded using correlatable lidar shots.

For instance, stereo imaging techniques may be applied to successive EO images in an EO image sequence (e.g., a selected plurality of EO images) to develop a 3D model of the subject matter. In these techniques, the rate of change of features within successive EO images in the sequence (and given a known position, rotation, and/or orientation of the EO imaging device) may provide information relating to the structure of the subject matter captured in the EO image sequence. For example, as the imaging device moves relative to objects, pixels corresponding to objects that are relatively close to the EO imaging device may change position within the EO image sequence more quickly than objects farther away from the EO imaging device. The lidar data may be used to predict this relative motion and identify matching portions of overlapping EO imaging devices to thereby seed the EO model generation process (e.g., by mapping one or more lidar shots to a selected plurality of the overlapping EO images).

Referring to the flow diagram of FIG. 3, at step 310, the method 300 may be initialized, which, as discussed above, may comprise loading executable program code from a computer-readable data storage media, allocating resources for the method 300 (e.g., allocating memory, data storage media, accessing communication interfaces, and the like), and/or initializing resource for the method 300 (e.g., initializing memory, data storage media, communications interfaces, and the like).

At step 320, the method 300 may position and/or orient a lidar and EO imaging device. The positioning and/or orienting of step 320 may comprise moving the lidar and EO imaging device to capture selected subject matter. The positioning and/or orienting of step 320 may comprise moving the lidar and EO imaging device over a capture area to capture subject matter spanning a large area (e.g., a coastline, large geological feature, or the like). Alternatively, or in addition, the moving may comprise changing an angle of view (e.g., orientation) of the lidar and EO imaging device to capture the subject matter from various points of view. Accordingly, the positioning and/or orienting of the lidar and EO imaging device described in step 320 may occur continuously during the method 300 (e.g., the lidar and EO imaging device may be disposed with a moving vehicle, such as a car, crane, aircraft, spacecraft, or the like).

At step 330, the method 300 may configure the lidar to begin capturing lidar data at a lidar capture rate. Also at step 330, the method 300 may configure an EO imaging device to begin capturing EO imagery data at an EO imagery capture rate. As discussed above, in method 200 and 201 the EO capture rate may be greater than the lidar capture rate, such that a particular portion of the subject matter scanned by the method 300 is captured by a plurality of overlapping EO images. Accordingly, a particular portion of the subject matter may be overlapped by 30 to 100 EO images or more, depending on the relative motion of the object relative to the lidar and EO imaging device. Similarly, a single lidar shot may fall within the FOV a similar number of overlapping EO images. However, other ratios could be achieved depending upon the relative capture rates of the lidar and EO imaging device, relative object motion, and/or the capabilities of the lidar and EO imaging device used in the method 300.

In some embodiments, at step 330, navigation and orientation sensing devices may be configured capture navigation and/or orientation measurements at a particular frequency. As discussed above in conjunction with FIG. 2B, navigation and orientation measurements may be obtained and stored in a continuous stream, independently of the lidar and EO imagery data. The navigation and sensor orientation of particular lidar shots and/or EO images may be obtained using the timing data associated therewith. Alternatively, and as discussed above in conjunction with FIGS. 1 and 2A, navigation and orientation data may be acquired concurrently with each lidar shot and EO image.

At steps 340 and 342, the EO imaging device and the lidar may be configured to asynchronously capture data. In addition, in some embodiments, at step 341, the method 300 may asynchronously capture navigation and sensor orientation data. The lidar may capture lidar data at a lidar capture rate within a lidar capture loop 340, and the EO imaging device may capture EO imagery data at an EO capture rate within an EO capture loop 342. The capture of lidar data at step 340 may be performed as described above, in conjunction with FIGS. 2A and/or 2B. For example, each lidar shot and/or EO image may be tagged and/or associated with navigation and timing data including, but not limited to: a time the EO image or lidar shot was obtained, a position of the EO imaging device or lidar, an orientation of the EO imaging device or lidar, and so on. The tagging and/or storage of the EO images and lidar shots may be performed as described above, in conjunction with FIGS. 1 and 2A. Alternatively, the lidar and EO imagery data may be time-stamped and may be correlated to an independent stream of navigation and sensor orientation data using the time stamp as described in conjunction with FIGS. 1 and 2B.

At step 350, the method 300 may determine whether the lidar and/or EO data acquisition should continue. If so, the flow may continue at step 340 or 342, where the lidar and/or EO imaging device may be configured to continue capturing EO imagery data and lidar data at their respective capture rates; otherwise, the flow may continue at step 360.

At step 360, the EO imagery data may be processed using a stereo imaging technique or other stereo imaging technique to develop a 3D model of the scanned subject matter. Although step 360 is shown as a separate step of the method 300 (occurring after acquisition of the lidar shots and EO images), one skilled in the art would recognize that the model generation of step 360 could be performed in “real-time” as the lidar shots and EO imagines are acquired (e.g., concurrently with the capture loops 340 and/or 342).

As discussed above, the EO imaging device may be capable of capturing EO imagery data at a higher frame rate and/or at a higher spatial resolution than the lidar. Moreover, high-resolution EO imaging devices may be more readily available and/or affordable than equivalent lidar devices. As such, it may be desirable to model the subject matter using the higher-resolution EO imagery data captured by the EO imaging device.

The EO imagery data may comprise a plurality of overlapping images (e.g., a particular portion of the scanned subject matter that is moving through the FOV may be captured by 30 to 100 EO images). Similarly, each lidar shot may fall within a similar number of overlapping EO images. As discussed above, the navigation and sensor orientation data may allow lidar shots to be correlated to one or more EO images (e.g., to one or more image patches within the EO images). These points may act as seeding points to aid in identifying and matching features within the sequence of EO images. Accordingly, the lidar shots may be used to seed the stereo imaging technique (or other modeling technique, such as videogrammetry or the like).

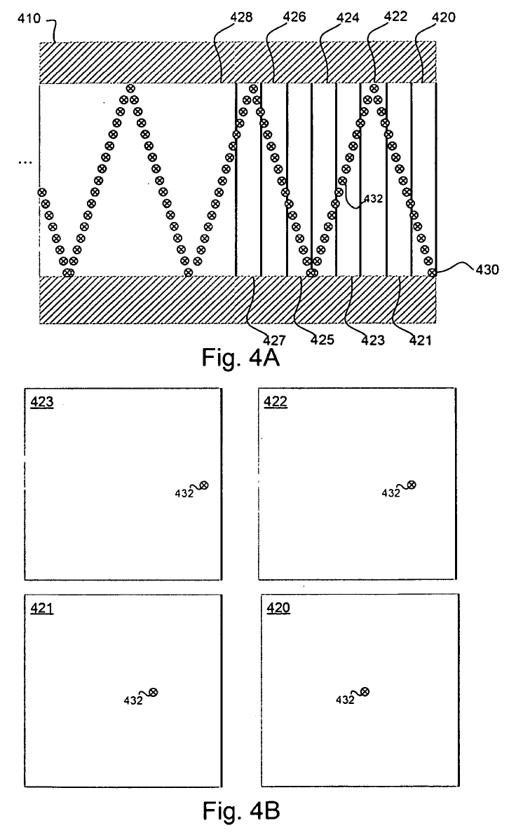

The system 100 and methods 200, 201, and 300 may generate sets of correlatable lidar and EO imagery data. As discussed above, the EO imagery data may comprise a plurality of overlapping EO images captured at an EO capture rate (e.g., 30 frames of EO imagery data per second). FIG. 4A shows one example of an area 410 (a portion of a particular subject matter) captured by a plurality of overlapping EO images 420-428 and lidar shots 430.

The EO images 420-428 and lidar shots 430 may have been asynchronously captured using the system 100 and/or using a method 200, 201, or 300. Using the navigation data and/or time stamps associated with the EO images 420-428 and lidar shots 430, the relative positions of the EO images 420-428 and lidar shots 430 on a portion of a particular subject matter may be correlated to one another. For example, the navigation and orientation data may allow the area 410 of the subject matter captured by a particular EO image 420-429 to be determined. Similarly, the navigation and orientation data may allow an area on which a particular lidar shot falls to be determined (e.g., lidar shot 432). As such, the FOV of the EO images 420-429, as well as the location of the lidar shots 430 within the EO images 420-429 may be determined and cross-correlated using the navigation data.

As seen in FIG. 4A, a number of lidar shots 430 may fall within one or more of the EO images 420-428. A single lidar shot (e.g., lidar shot 432) may be mapped into a selected plurality of overlapping EO images. For example, the lidar shot 432 may map to the FOV of EO images 420-424.

FIG. 4B shows the mapping of the lidar shot 432 into EO images 420-423. As used herein, mapping a lidar shot (such as lidar shot 432) to an EO image (e.g., EO images 420-423) may comprise identifying one or more pixels within the EO image (an image patch) upon which the lidar shot falls. Alternatively, it may comprise identifying an image coordinate within a pixel of the EO image. The mapping may be calculated using the navigation (and sensor orientation) information associated with the EO images and lidar data. As seen in FIG. 4B, the lidar shot 432 is mapped to different portions (e.g., image patches) of the overlapping EO images 420-423. The location of the lidar shot 432 in the images 420-423 may be used to seed an image-matching algorithm, since the location of the lidar shot 432 in the images 420-423 may represent the same feature and/or location within the subject matter 410 within the EO images 420-423. Accordingly, the locations of the lidar shot 432 within the EO images 420-423 may be used as a starting point (e.g., seed) to match features within the EO images 420-423. This image matching may form part of an EO imagery-based modeling technique, such as stereo imaging, videogrammetry, or the like. The seeding may increase the accuracy and/or decrease the computation time of the stereo imagery based modeling technique.

Although FIGS. 4A and 4B show a lidar shot 432 falling within four (4) EO images, one skilled in the art would recognize that a lidar shot should could map to any number of overlapping EO images, depending upon the capture rate of the EO imaging device, capture rate and/or scan pattern of the lidar, movement speed of the system, and the like. For example, in some configurations and relative object motions, a lidar shot may fall within the FOV of 30 to 100, or even thousands of overlapping EO images.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product, including a computer-readable medium having stored instructions thereon that may be used to program a computer (or other electronic device) to perform processes described herein. The computer-readable medium may include, but is not limited to: hard drives, floppy diskettes, optical discs, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc., that perform one or more tasks or implements particular abstract data types.

In certain embodiments, a particular software module may include disparate instructions stored in different locations of a memory device, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of this disclosure.

What is claimed is:

1. A system for asynchronously capturing correlatable lidar and EO imagery data to generate a model of a subject matter, the system comprising:
a computer-readable storage media;
a lidar;
an electro-optical (EO) imaging device;
a system controller comprising a processor, the system controller communicatively coupled to the computer-readable storage media, the lidar, and the EO imaging device,
wherein the system controller is configured to cause the lidar to capture a plurality of lidar shots of the subject matter at a lidar capture rate and to cause the EO imaging device to capture a plurality of overlapping EO images of the subject matter at an EO image capture rate, and
wherein the system controller is configured to acquire navigation data as the lidar shots and the EO images are captured; and
a modeler communicatively coupled to the system controller, the modeler configured to generate a model of the subject matter based on the plurality of overlapping EO images using a stereo imaging technique, wherein the stereo imaging technique is seeded using the lidar shots.

2. The system of claim 1, wherein the modeler is configured to seed the stereo imaging technique by mapping a lidar shot into a selected plurality of overlapping EO images.

3. The system of claim 1, wherein the modeler is configured to map the lidar shot into the selected plurality of overlapping EO images using the navigation data of the lidar shot and the navigation data of the plurality of overlapping EO images.

4. The system of claim 1, wherein the EO image capture rate is greater than the lidar capture rate.

5. The system of claim 1, wherein the EO images have a higher spatial resolution than the lidar shots.

6. The system of claim 1, further comprising a time source communicatively coupled to the system controller, wherein the system controller is configured to time stamp each of the plurality of lidar shots with a time the lidar shot was captured, and wherein the system controller is configured to time stamp each of the EO images with a time the EO image was captured.

7. The system of claim 6, further comprising:
a positioning system receiver communicatively coupled to the system controller, wherein the system controller is configured to acquire the navigation data using the positioning system receiver.

8. The system of claim 7, wherein the positioning system receiver is a global positioning system (GPS) receiver.

9. The system of claim 7, wherein the system controller is communicatively coupled to a secondary positioning system receiver disposed at a predetermined location, wherein the system controller is configured to refine the navigation data using positioning information received from the secondary positioning system receiver.

10. The system of claim 9, wherein the secondary positioning system receiver is a GPS receiver, and wherein the location of the secondary positioning system receiver is fixed.

11. The system of claim 7, wherein the system controller is configured to time stamp the navigation data with a time the navigation data was acquired.

12. The system of claim 11, wherein the modeler is configured to associate a particular lidar shot with corresponding navigation data using the time stamp of the particular lidar shot and the time stamp of the navigation data.

13. The system of claim 7, further comprising:
an inertial measurement unit (IMU) coupled to the lidar and the EO imaging device, the IMU communicatively coupled to the system controller, wherein the system controller is configured to refine the navigation data using the IMU.

14. The system of claim 13, wherein the IMU is configured to determine an orientation of the lidar and the EO imaging device, and wherein the navigation data comprises the orientation of the lidar and the orientation of the EO imaging device.

15. A method for asynchronously capturing correlatable lidar data and EO imagery data to develop a model of a subject matter therefrom, the method comprising:
a lidar capturing a plurality of lidar shots of the subject matter;
an EO imaging device capturing a plurality of overlapping EO images of the subject matter, wherein the lidar and the EO imaging device are configured to capture lidar shots and EO images asynchronously;
acquiring navigation data as the lidar shots and EO images are captured;
associating the plurality of lidar shots and the plurality of overlapping EO images with respective navigation data;
generating a model of the subject matter based on the plurality of overlapping EO images using a stereo imaging technique, wherein the stereo imaging technique is seeded using one or more of the plurality of lidar shots.

16. The method of claim 15, wherein the stereo imaging technique is seeded by mapping the one or more lidar shots into a selected plurality of overlapping EO images.

17. The method of claim 16, wherein mapping the lidar shot into the selected plurality of overlapping EO images comprises using the navigation data of the lidar shot and the navigation data of the plurality of overlapping EO images to map the lidar shot to respective image patches within the selected plurality of overlapping EO images.

18. The method of claim 17, wherein seeding the stereo imaging technique comprises seeding an image matching process using the lidar shot mappings.

19. The method of claim 15, wherein the navigation data is acquired from a positioning system receiver.

20. The method of claim 18, wherein the positioning system receiver is a global positioning system (GPS) receiver.

21. The method of claim 19, further comprising:
acquiring navigation data from a secondary positioning system receiver; and
refining the navigation data using the navigation data from the secondary positioning system receiver.

22. The method of claim 20, wherein the location of the secondary positioning system receiver is fixed.

23. The method of claim 19, further comprising:
acquiring an orientation of the lidar as each of the lidar shots is captured; and
acquiring an orientation of the EO imaging device as each of the EO images is captured, wherein the navigation data comprises the orientation of the lidar and the EO imaging device.

24. The method of claim 23, wherein the orientation of the EO imaging device is acquired from an inertial measurement unit (IMU) coupled to the EO imaging device.

25. The method of 24, further comprising:
time stamping each of the lidar shots with a time the lidar shot was captured;
time stamping the navigation data with a time the navigation data was acquired; and
associating a lidar shot with navigation data using the time stamp of the lidar shot and the time stamp of the navigation data.

26. The method of claim 25, further comprising time stamping each of the EO images with a time the EO image was captured; and
associating an EO image with navigation data using the time stamp of the EO image and the time stamp of the navigation data.

27. A computer-readable storage medium comprising instructions to cause a computing device to perform a method for asynchronously capturing correlatable lidar and EO imagery data to generate a model of a subject matter, the method comprising:
a lidar capturing a plurality of lidar shots of the subject matter, wherein each of the lidar shots comprises a time stamp indicating the time the lidar shot was captured;
an EO imaging device capturing a plurality of overlapping EO images of the subject matter, wherein each of the EO images comprises a time stamp indicating the time the EO image was captured, wherein the lidar shots and EO images are captured asynchronously;
acquiring time stamped navigation data as the lidar shots and EO images are captured, wherein the navigation data comprises an orientation of the lidar and an orientation of the EO imaging device;
mapping a particular lidar shot onto a selected plurality of overlapping EO images using the navigation data; and
seeding a stereo imaging technique using the mapping.

28. A system for asynchronously capturing correlatable lidar and EO imagery data to generate a model of a subject matter, the system comprising:
a computer-readable storage media;
a lidar;
two or more electro-optical (EO) imaging devices;
a system controller comprising a processor, the system controller communicatively coupled to the computer-readable storage media, the lidar, and the two or more electro-optical (EO) imaging devices,
wherein the system controller is configured to cause the lidar to capture a plurality of lidar shots of the subject matter at a lidar capture rate and to cause the two or more electro-optical (EO) imaging devices to capture a plurality of overlapping EO images of the subject matter at an EO image capture rate, and
wherein the system controller is configured to acquire navigation data as the lidar shots and the EO images are captured; and
a modeler communicatively coupled to the system controller, the modeler configured to generate a model of the subject matter based on the plurality of overlapping EO images using a stereo imaging technique, wherein the stereo imaging technique is seeded using the lidar shots.
